(19) United States
(12) Patent Application Publication
(10) Pub. No.: US 2009/0045169 A1
(43) Pub. Date: Feb. 19, 2009

(54) Mirror etching composition

(76) Inventor: Timothy Ray Poe, Birmingham, AL (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/221,503

(22) Filed: Aug. 4, 2008

Related U.S. Application Data
(63) Continuation-in-part of application No. 11/973,416, filed on Oct. 9, 2007.
Application No. 11/973,416 is a division of application No. 10/711,183, filed on Aug. 31, 2004, now abandoned.

(51) Int. Cl. B44C 1/22; C09K 13/02

(52) U.S. Cl. 216/97; 252/79.5

(57) ABSTRACT

A mirror etching composition comprising a solution of water, sulfated potash and vegetable glycerin and, when applied to the electroplated non-reflective surface of a mirror, effectively simulates the appearance of a tarnished or deteriorated “antique” mirror. The electroplated surface applied to the back of new mirrors is normally sealed with a painted protective coating. In order to etch the electroplated surface on new mirrors, the painted protective coating must be stripped with a paint or varnish remover to expose the electroplated surface. After this mirror etching composition is applied to the electroplated non-reflective surface and the desired effect has been achieved, the electroplated surface may be sealed with a painted protective coating. New mirrors that have been electroplated and not yet sealed with a painted protective coating may be treated with this mirror etching composition before sealing.

This application is a continuation-in-part of U.S. patent application Ser. No. 11/973,416, filed Oct. 9, 2007, which is a division of U.S. patent application Ser. No. 10/711,183, filed Aug. 31, 2004.

When applied to the electroplated surface on the back. (i.e., non-reflective surface) of a mirror, the composition of this invention will effectively simulate the appearance of a tarnished or deteriorated “antique” mirror when viewed from the front of the mirror. (i.e., the reflective surface of the mirror).

The effects or degree of tarnish and deterioration on the electroplated surface may be controlled by adjusting the ratio of the composition, the temperature of the composition and/or the method of application of the composition.

The mirror etching composition of this invention comprises a solution of sulfated potash, vegetable glycerin and water.

When used in this application, the following terms will be understood to have the following definitions:
“potash”—potassium or a potassium-containing compound, such as potassium carbonate.
“sulfated”—a sulfer-containing potash; also sulferated.
“vegetable glycerin”—glycerin derived from a vegetable source.

In the composition of this invention, the sulfated potash can be used in an amount of from about one teaspoon to about one tablespoon per gallon of water.

Further, in the composition of this invention, the vegetable glycerin can be used in an amount of about 1:1 based on the sulfated potash.

Vegetable glycerin is used to extend the shelf life of the sulfated potash, as the sulfated potash tends to degrade within a short time (sometimes as little as 72 hours). In combination with the vegetable glycerin, the shelf life of the sulfated potash is extended for several months (sometimes as much as 18 months).

The use of vegetable glycerin also enables the composition of this invention to remain on the electroplated non-reflective surface of the mirror for a longer period of time to cover and tarnish or distress a greater percentage of that surface.

When using a smaller amount of sulfated potash and vegetable glycerin, this composition will produce only a light tarnished or distressed effect when applied at room temperature to the electroplated non-reflective surface of a mirror. However, when using a larger amount of sulfated potash and vegetable glycerin, this composition will produce a light charcoal gray tarnished or distressed effect when applied at room temperature to the electroplated non-reflective surface of a mirror.

When using a larger amount of sulfated potash and vegetable glycerin, the composition of this invention will produce a dark charcoal gray or heavy distressed effect when applied at a higher temperature (for example, about 140° F.) to the electroplated non-reflective surface of a mirror.

The method by which the composition of this invention is applied will also affect the appearance of the reflective mirror surface. There are various methods of application such as spraying, pouring, dipping and/or brushing the composition onto the electroplated surface on the back of a mirror.

After the desired “antique” mirror effect is achieved, and after the surface of the etched electroplated surface on the back of the mirror is dry, the etched electroplated surface may be sealed with a painted protective coating.

This invention has been described in detail with particular reference to certain embodiments, but variations and modifications can be made without departing from the spirit and scope of the invention as defined in the following claims.

What is claimed is:

1. A composition which comprises sulfated potash, vegetable glycerin and water.

2. A composition as defined by claim 1 wherein the composition comprises sulfated potash in a ratio of about one teaspoon of sulfated potash to about one gallon of water.

3. A composition as defined by claim 1 wherein the composition comprises sulfated potash in a ratio of about one tablespoon of sulfated potash to about one gallon of water.

4. A composition as defined by claim 1 wherein the composition comprises vegetable glycerin in a ratio of about 1:1 to sulfated potash.

5. A method for tarnishing an electroplated non-reflective surface of a mirror, wherein the method comprises applying to the electroplated non-reflective surface a composition which comprises sulfated potash, vegetable glycerin and water.

6. A method as defined by claim 5 wherein the composition is applied to the electroplated non-reflective surface by spraying, pouring, dipping or brushing.

7. A method as defined by claim 5 wherein the composition comprises sulfated potash and water in a ratio of about one teaspoon of sulfated potash to about one gallon of water.

8. A method as defined by claim 5 wherein the composition comprises sulfated potash and water in a ratio of about one tablespoon of sulfated potash to about one gallon of water.

9. A method as defined by claim 5 wherein the composition comprises vegetable glycerin in a ratio of about 1:1 to sulfated potash.
